(19) United States
(12) Patent Application Publication
(10) Pub. No.: US 2008/0192147 A1
(43) Pub. Date: Aug. 14, 2008

(54) Apparatus for generating compressed image data and apparatus and method for displaying the compressed image data

(75) Inventor: Kwang-Cheol Choi, Gwacheon-si (KR)

Correspondence Address: DOCKET CLERK, P.O. DRAWER 800889, DALLAS, TX, 75380, US

(73) Assignee: Samsung Electronics Co., Ltd., Suwon-si (JP)

(21) Appl. No.: 11/901,362

(22) Filed: Sep. 17, 2007

(30) Foreign Application Priority Data
Feb. 8, 2007 (KR) 2007-13239

(51) Int. Cl. H04N 9/64

(52) U.S. Cl. 348/716; 348/E09.037

(57) ABSTRACT

An apparatus and method for generating compressed image data, and outputting decoded images using the compressed image data. A compressed image data generation unit receives and compresses image data taken from a first camera arranged to generate an additional image and inserts the compressed image data into a specified area of the compressed image data generated using a picture image received from a second camera arranged to generate an ordinary image. An image output apparatus receives the compressed image data including the compressed picture image data, determines whether the compressed picture image data exists. If the compressed picture image data are present, the apparatus decodes the image data to generate a three-dimensional stereoscopic image as output using the ordinary image and the additional image. However, if the image output apparatus is not capable of three-dimensional image generation, it only provides the ordinary image.

### CROSS-REFERENCE TO RELATED APPLICATION(S) AND CLAIM OF PRIORITY

The present application claims the benefit under 35 U.S.C. §119(a) of a Korean Patent Application filed in the Korean Intellectual Property Office on Feb. 8, 2007 and assigned Serial No. 2007-13239, the disclosure of which is incorporated herein by reference.

### TECHNICAL FIELD OF THE INVENTION

The present application relates generally to compression of image data, and more particularly to generation of three-dimensional (3D) compressed image data.

### BACKGROUND OF THE INVENTION

One of the conventional ways of producing a three-dimensional (3D) image is to utilize binocular disparity, that is, a difference in vision between left and right eyes of a person who is viewing an object. It is well known in the art that the binocular disparity results from the fact that a person's left and right eyes are positioned apart from each other, so that an image viewed with the left eye is slightly different from that viewed with the right eye. Hence, it is known that generation of a three-dimensional stereoscopic image as viewed from a person's eyes may be implemented using at least two (e.g., left and right) cameras disposed apart from each other, as is in a person's eyes, wherein a set of image data input from the respective cameras are merged together to produce a three-dimensional image. A resultant image made by the merge of the left and right images will be of the form that the two respective images, taken by the left and right cameras, have been merged into one image, that is, rendering a so-called three-dimensional stereoscopic image when finally viewed from a person's eyes. A typical three-dimensional imaging apparatus may be designed in such a way that it decodes the three-dimensional image data received and then provides its user with the three-dimensional view of the image utilizing three-dimensional image processing.

As described above, a set of image data used for generation of such a three-dimensional (3D) stereoscopic image are generally made by merging two different images. Thus, if an image output apparatus not adapted to generation of a 3D image receives 3D stereoscopic image data used only for generation of a 3D image, the 3D image received will not be actually displayed as a three-dimensional view of the image, but will be displayed merely in a simply merged form of two different images. Therefore, a prior art 3D image output system will have a disadvantage that, when an image output apparatus not adapted to generation of 3D image is arranged to receive a 3D image, the output images displayed from the image output apparatus will result in considerable degradation in quality.

### SUMMARY OF THE INVENTION

To address the above-discussed deficiencies of the prior art, it is a primary object to provide an apparatus and method for generating compressed image data, in which an image output apparatus can adaptively provide either a three-dimensional (3D) image output or a usual, two-dimensional (2D) image output, depending upon whether the image output apparatus is equipped with the capability of outputting a three-dimensional image.

Another aspect of the present invention is to provide an apparatus and method for receiving compressed image data and displaying output image based on the compressed image data, adaptively either in a stereoscopic 3D image or a usual 2D image, depending upon whether an image output apparatus is capable of outputting the three-dimensional image.

In one aspect of the present invention, an apparatus for generating compressed image data includes a memory for storing a plurality of images for generating a three-dimensional stereoscopic image, a user data generation unit for generating a set of user data by compressing at least one of the images stored in the memory, a compressed image data generation unit for generating the compressed image data from any one of the stored images, and after inserting the user data into a specified area of the compressed image data, marking the compressed image data with an indication that the user data have been inserted thereto, and a controller for controlling the user data generation unit and the compressed image data generation unit, said controller adapted to deliver the images stored in the memory to the user data generation unit and the compressed image data generation unit, and to deliver the user data generated from the user data generation unit to the compressed image data generation unit, so as to produce the compressed image data with the user data inserted thereto.

Advantageously, the compressed image data generation unit is configured to indicate that the user data were included in the compressed image data, using a user data flag or a user data start code.

Preferably, the controller is configured to extract an image not selected as an additional image and deliver the extracted image to the compressed image data generation unit.

In another aspect of the present invention, a method for generating compressed image data includes the steps of: storing a plurality of images for generating a three-dimensional stereoscopic image; selecting at least one of the stored images as an additional image; generating user data by compressing the additional image; selecting any one of the stored images as an ordinary image; generating compressed image data using the ordinary image; inserting the user data into the compressed image data; and marking the compressed image data with an indication that the user data were inserted thereto.

Preferably, said step of marking the compressed image data is to indicate that the user data were included in the compressed image data, using a user data flag or a user data start code.

Advantageously, said ordinary image is an image not selected as the additional image of the stored images.

In still another aspect of the present invention, an image output apparatus for outputting an image extracted from compressed image data includes a display unit adapted to generate and output a three-dimensional stereoscopic image under control of a controller, an image data decoding unit for decoding the compressed image data received to extract an ordinary image, and if there exist user data, extracting the user data from the compressed image data, a user data decoding unit for extracting at least one additional image by decoding the user data, and the controller for controlling the image data decoding unit to extract the ordinary image by applying the received compressed image data to the image data decoding unit, controlling the user data decoding unit to extract the additional image by applying the user data extracted from the image data decoding unit to the user data decoding unit, and controlling the display unit to generate a three-dimensional stereoscopic image using the ordinary image and said at least one additional image as an output image.

Preferably, the controller is configured to determine whether an user data flag or a user data start code indicative of an inclusion of the user data have been included in the compressed image data, and in case of the inclusion of the user data, to control the image data decoding unit to extract the user data.

In further aspect of the invention, a method for outputting an image extracted from compressed image data includes the steps of: extracting an ordinary image by decoding the compressed image data received; determining whether the decoded compressed image data include user data or not; extracting the user data in case where the compressed image data include the user data; extracting at least one additional image by decoding the extracted user data; generating a three-dimensional stereoscopic image by performing a stereoscopic image processing with respect to the extracted additional image and the ordinary image; and outputting the three-dimensional stereoscopic image generated using said stereoscopic image processing through a image output apparatus.

Preferably, the step of determining whether the decoded compressed image data include user data includes confirming the user data flag or the user data start code to determine whether the user data were included in the compressed image data.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 shows a schematic block diagram of an apparatus for generating compressed image data according to a preferred embodiment of the present invention;

FIGS. 2A and 2B show an exemplary format of conventional compressed image data;

FIG. 3 shows a flow chart of generating a three-dimensional image file in the apparatus for generating compressed image data in accordance with a preferred embodiment of the present invention;

FIG. 4 shows a schematic block diagram of an apparatus for outputting compressed image data according to a preferred embodiment of the present invention; and

FIG. 5 shows a flow chart of outputting the image data in the apparatus for outputting compressed image data in accordance with the preferred embodiment of the present invention.

### DETAILED DESCRIPTION OF PREFERRED EMBODIMENTS

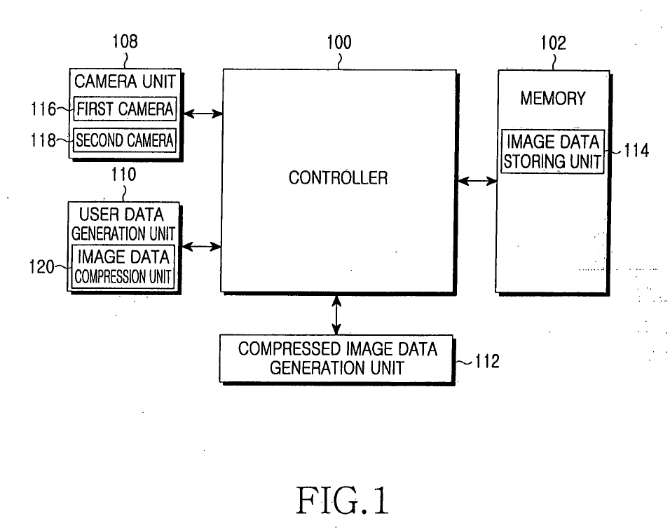

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged image processing system.

Hereinafter, an exemplary embodiment of the present invention will be described in more detail with reference to the annexed drawings. In the drawings, the same or similar elements are denoted by the same reference numerals even though they are depicted in different drawings. In the following description, a detailed description of known functions and configurations incorporated herein will be omitted when it may make the subject matter of the present invention unclear.

For better understanding to the present invention, a basic principle of the present invention will be now explained. According to the preferred embodiment of the invention, a compressed image data generation apparatus serves to receive a series of picture images from a camera arranged to produce an additional image for generation of a three-dimensional image, and then makes a compression of the received picture images. Further, the compressed image data generation apparatus also serves to insert the compressed picture image data into a specified portion of an image compression data produced from a picture image provided by a camera arranged to produce a usual, two-dimensional image. That is to say, additional information of compressed image data added for a generation of the three-dimensional image in the disclosed embodiment (hereinafter, referred to as “user data”) is stored in a user data area where a user may use as desired without a particular limitation in use of a general data format of image compression.

Then, an image output apparatus that receives the compressed image data, including the compressed picture image data, determines whether there is any compressed pictured image data according to a capability of generating the three-dimensional image. Thus, if the compressed pictured image data is present, the image output apparatus serves to decode the image data, and then generates the three-dimensional image as an output utilizing the additional image as well as the general image. However, if the image output apparatus is unable to generate three-dimensional images, the image output apparatus outputs only the general image. Accordingly, the present invention will make it possible to output the received three-dimensional image either as a three-dimensional image or as a usual, two-dimensional image, depending upon whether the image output apparatus device is capable of generating three-dimensional images.

Referring now to FIG. 1, a three-dimensional image (3D) compressed data generation apparatus according to a preferred embodiment of the present invention includes a controller or control unit 100, a memory 102 connected with the controller 100, a camera unit 108 having one or more cameras, a user data generation unit 110 electrically connectable with the controller, and a compressed image data generation unit 112 electrically connectable with the controller. The controller 100 performs a series of data processing under the control of a predetermined protocol, and controls its peripheral units. The controller 100 is configured to receive a picture image respectively from a first camera 116 of the camera unit 108, arranged to make an additional image for generation of the three-dimensional (3D) image, and a second camera 118 of the camera unit, arranged to make a common image for generation of an ordinary two-dimensional (2D) image. Then, the controller 100 makes a compression of the picture image received from the first camera 116 to produce an additional image, and produces “compressed” image data using the picture image input from the second camera 118. Here, the compressed image data is referred to as the data compressed to a data format prescribed for a safe transfer of image data, such as an MPEG 4 standard format.

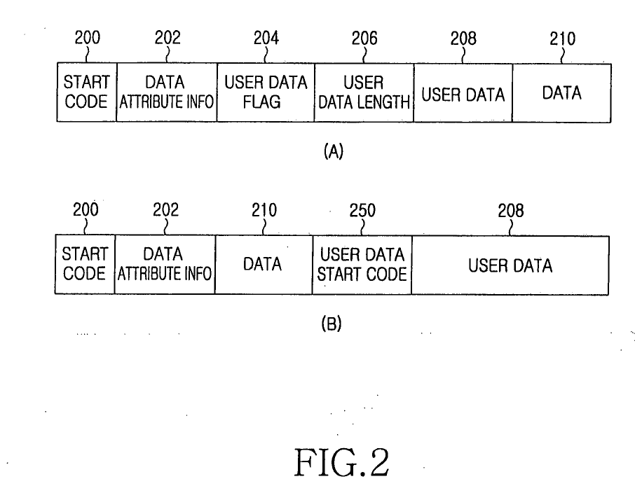

This compressed image data, as seen in FIGS. 2A and 2B, may include a Start Code 200 indicating a starting point of data, a Data Attribute Information 202 required for interpretation of subsequent data, a user data flag 204, actual compressed data 210, and a User Data 208 inserted by a user as desired. The user data may not be included within the compressed image depending upon the user's selection. Accordingly, the compressed image data with inclusion of the user data can be represented in several different formats, as seen in the data format of FIGS. 2A and 2B each illustrating examples of the compressed image data as the location of the user data area changes.

FIG. 2A shows an example of the compressed image data applicable to an occasion that a determination can be made as to whether the User Data 208 is included or not, using the User Data Flag 204. Referring again to FIG. 2A, the compressed image data using the User Data Flag 204 may include a Start Code 200, a Data Attribute Information 202, a User Data Flag 204, a User Data Length Information 206, User Data 208, and Data 210 having actual compressed image data. Here, the Start Code 200 is a code indicating a starting point of the compressed image data, and the Data Attribute Information 202 includes the various information required for interpretation of the data, as aforementioned. Further, the User Data Flag 204 is used to indicate whether the user data exist or not, shown in either “1” or “0” depending upon existence of the user data. Therefore, the image output apparatus that has received this format of compressed image data will be able to check a value of the User Data Flag 204 to determine whether the User Data 208 is included in the compressed image data. Further, in case the User Data 208 exists, the image output apparatus determines the volume of the user data from the User Data Length information 206, and takes out the User Data 208.

FIG. 2B shows an example of the compressed image data applicable to an occasion that a determination can be made as to whether the User Data 208 is included or not, using the User Data Start Code 250. Referring again to FIG. 2B, the compressed image data using the user data start code may include a Start Code 200, a Data Attribute Information 202, a User Data Start Code 250, User Data 208, and Data 210 having actual compressed image data. Here, the User Data Start Code 250 is used to indicate the existence of the user data to the compressed image data generation apparatus and the image output apparatus. Hence, when the user data exists, the compressed image data generation apparatus (or device) produces the compressed image data with insertion of the user data start code 250, and upon receipt of these compressed image data, the image output apparatus (or device) makes a determination that data received subsequently to the user data start code 250 from the compressed image data are actually the user data.

The controller 100 supplies normal two-dimensional (2D) image input from the second camera 118 of the camera unit to the compressed image data generation unit 112, and then causes the compressed image data generation unit 112 to make a series of compressed image data utilizing the normal 2D image. The controller 100 also provides the user data generation unit 110 with additional images input from the first camera 116 for compression of the images, thereby generating the user data. Once the user data have been produced, they are applied to the compressed image data generation unit 112 for insertion into the compressed image data as the user data. Inclusion of the user data can be represented using the Data Flag 204 or User Data Start Code 250.

In the meantime, the memory 102 connectable with the controller 100 may include a Read Only Memory (ROM), a flash memory, and a Random Access Memory (RAM). The memory 102 is configured to store therein a set of programs and reference data for use in processing and control of the controller 100, and to serve as a working memory for various operations in the controller 100. The memory 102 may also include a memory area for storing a variety of temporary data to be updated as required. Further, the memory 102 may include a memory area for storing the ordinary image and/or additional image input from the camera unit 108, which memory area will be hereafter referred to as “image data storing unit 114”.

The user data generation unit 110 includes an image data compression unit 120 to compress the input image under control of the controller 100, as described above, and the user data generation unit 110 operates to return the compressed image to the controller 100 as the user image. Further, the compressed image data generation unit 112 produces compressed image data using the ordinary 2D image input under the control of the controller 100. Then, the user data from the user data generation unit 110 are delivered to the compressed image data generation unit 112 through the controller 100, for insertion into the compressed image data as the user data. As such, in the embodiment of the present invention as described heretofore, it will be appreciated that the additional image for use in making 3D image can be transferred as the user data with the compressed image data. Therefore, according to the present invention, an image output apparatus (or device) makes a check on the compressed image data to extract the additional image inserted as the user data, and in cases where the image output apparatus (or device) is capable of providing a 3D image, it can generate the 3D image by means of using the additional image and the ordinary 2D image made of the compressed image data. Here, it should be appreciated that in cases where the output image apparatus device is incapable of provision of 3D picture, it could merely provide an output of pictures using the ordinary 2D image included in the compressed image data. Therefore, it will be noted that the image output device according to the present invention can make an output of ordinary 2D images without any significant damage of pictures, even if the compressed image data concerns generation of 3D image but the output device has no function of generation of 3D image.

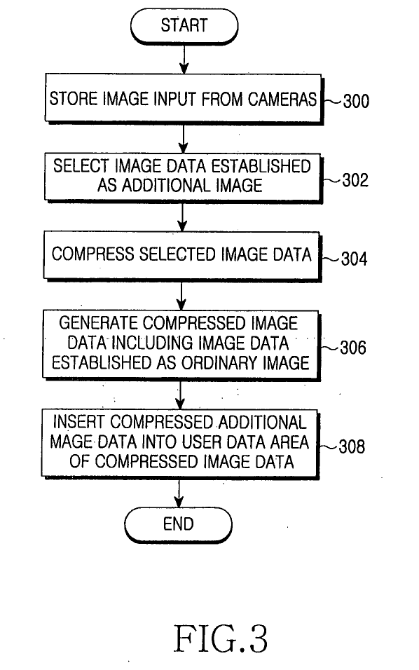

Referring now to FIG. 3, the description will be made to an operation for generating a 3D image file in a compressed image data generation unit 112 according to a preferred embodiment of the present invention. As shown in a flow chart of FIG. 3, the controller 100 of the compressed image data generation unit 112 according to the preferred embodiment of the present invention stores in Step 300 a series of picture images input from cameras as it initiates an operating sequence of generating a set of compressed image data. Then, the control sequence proceeds to Step 302 to select image data established as additional image of the picture images. Subsequently, the control sequence proceeds in Step 304 to supply the image data established as additional image to the user data generation unit 110.

The controller 100 proceeds in Step 306 to select image data established as an ordinary image of the picture images and supplies the image data established as an ordinary image of the picture images to the compressed image data generation unit 112 for generation of the compressed image data. Then, the controller 100 proceeds in Step 308 to insert the compressed data of the additional image into a user data area of the compressed image data, and then indicates the presence of the user data using the user data flag 204 or the user data start code 250.

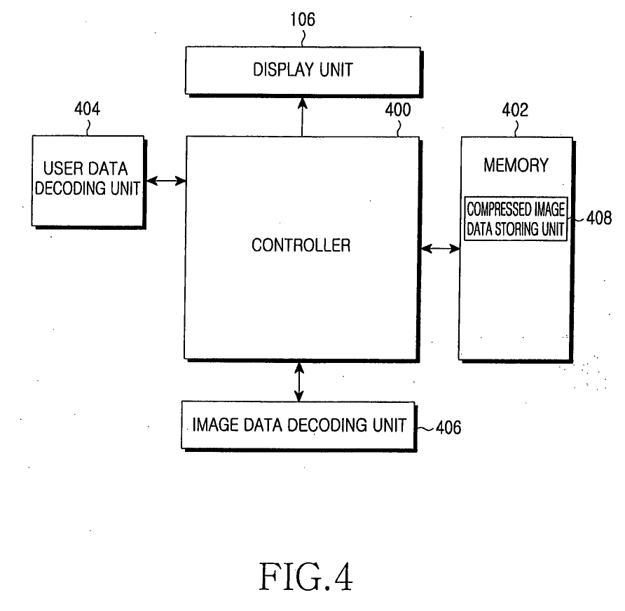

FIG. 4 shows a schematic block diagram of an image output apparatus for decoding and outputting the compressed image data according to the preferred embodiment of the present invention. Referring now to the block diagram of FIG. 4, the image output apparatus includes a controller 400, a memory 402 connected to the controller 400, a display unit 106, an image data decoding unit 406, and a user data decoding unit 404. In this embodiment, the controller 400 is adapted to perform a set of data processing operations required in accordance with a predetermined protocol and to control a respective unit or peripherals operatively coupled with the controller 400. Once the controller 400 has received the compressed image data, it delivers the data to the image data decoding unit 406 for a decoding. Hence, an ordinary 2D image data will be taken from the image data decoding unit 406.

In the meantime, in case the image output apparatus is capable of 3D picture image generation, the controller 400 of the image output apparatus according to the preferred embodiment of the present invention makes a determination as to whether the user data 208 is included in the decoded compressed image data or not. Here, whether or not the user data 208 have been included in the decoded compressed image data can be determined using the user data flag 204 or the user data start code 250. In cases where there are the user data 208, the controller 400 extracts user data to deliver the user data to the user data decoding unit 404. Further, the controller 400 causes the user data decoding unit 404 to decode the user data to extract an additional image from the decoded user data. Then, both the ordinary image and the additional image extracted are supplied to the display unit 106, which performs 3D image processing of the ordinary image and the additional image to output a 3D picture image.

However, in case the output apparatus is incapable of 3D picture image generation, the controller 400 of the image output apparatus according to the preferred embodiment of the present invention applies the ordinary image extracted from the image data decoding unit 406 directly to the display unit 406. Thus, the ordinary image without 3D presentation of image will be output from the display unit 106, thereby making an ordinary 2D picture image on display. Therefore, it will be appreciated that the image output apparatus adapted to receive and output compressed image data according to the present invention makes it possible to represent an output image in either 2D or 3D picture, depending upon a determination as to whether the image output apparatus is capable of 3D picture generation.

Referring again to FIG. 4, the memory 402 connected with the controller 402 may include a Read Only Memory (ROM), a flash memory, and/or a Random Access Memory (RAM). The memory 402 may be configured to store therein a set of software programs and reference data for use in processing and control of the controller 400, and to serve as a working memory used for various operations in the controller 400. The memory 402 may also include a memory area for storing a variety of temporary data to be updated as required under control of the controller 400. Further, the memory 402 may include a memory area for storing the compressed image data received, which memory area will be hereafter referred to as “compressed image data storage unit 408”.

The image data decoding unit 406 decodes the compressed image data received under the control of the controller 400, and then makes a determination as to whether the user data 208 exists or not by checking the information in the user data flag 204 or the user data start code 250. Hence, in cases where the user data 208 exists, the controller 400 causes the user data 208 to be extracted and returned to the controller 400.

In the meantime, the user data decoding unit 404 receives the user data 208 from the controller 400 and decodes the user data. As described in the foregoing, the compressed image data generated according to the embodiment of the present invention is configured to include the compressed additional image for generation of a 3D image in the user data, so that the additional image can be extracted by decoding the user data. After extracting the additional image, the user data decoding unit 404 then returns this image to the controller 400.

The display unit 106 provides a 3D or 2D image depending upon whether the image output apparatus is capable of 3D image generation, under the control of the controller 400. If the image output apparatus is equipped with the a function capable of 3D picture image generation, the display unit 106 merges the ordinary image and the additional image so as to perform a 3D picture generation process and outputs the 3D picture image. However, in cases where the image output apparatus is incapable of 3D picture image generation, that is to say, for example, the apparatus has no merging function for the ordinary image and the additional image, the controller 400 causes the display unit 106 to output only the ordinary image.

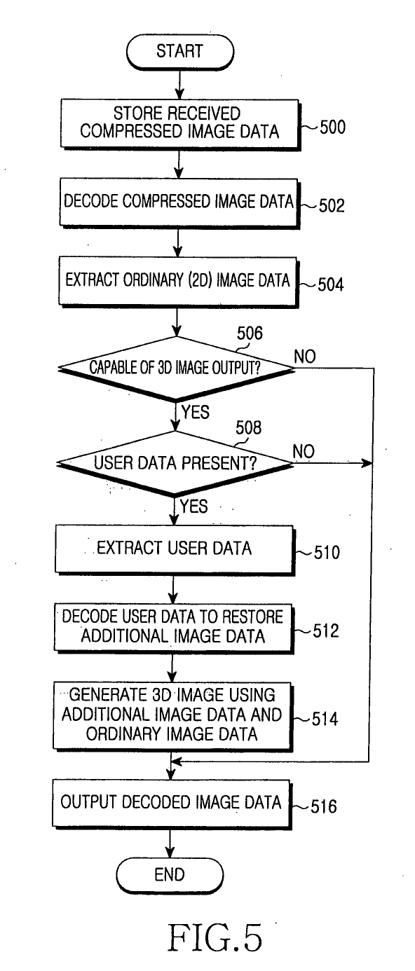

Referring now to FIG. 5, the description will be made to a flow chart for the control sequence for outputting the picture image in the image output apparatus according to the preferred embodiment of the present invention. In the embodiment of the present invention, the controller 400 in Step 500 receives the compressed image data and stores the compressed image data. Then, the controller 400 in Step 502 causes decoding of the received compressed image data. Hence, ordinary image data included in the compressed image data are decoded, and the controller 400 extracts in Step 504 the decoded ordinary image data. As such, the controller 400 makes a determination as to whether the image output apparatus is capable of outputting a 3D image, that is to say, generation of 3D picture image. In cases where it is capable of generation of 3D pictures, the controller 400 in Step 508 determines whether the user data is included with the decoded compressed image data or not. If the user data is included, the controller 400 in Step 510 extracts the user data and applies the user data to user data decoding unit 404.

The controller 400 controls the user data decoding unit 404 and recovers the additional image data from the user data. Once the additional data have been recovered, the controller 400 in Step 514 supplies the additional image data and the ordinary image data to the display unit 406, which then produces a 3D picture image using the additional image and the ordinary image. Then, the controller 400 in Step 516 causes the display unit 406 to output the generated 3D picture image.

However, if either the determination in the Step 506 indicates the image output apparatus is incapable of generation of 3D picture image or the determination in Step 508 indicates the user data are not include, then the controller 400 supplies to the display unit 106 the ordinary image data extracted in Step 504 and proceeds in Step 516 to output the ordinary image data through the display unit 406. As such, the display unit 106 is provided only the ordinary image output without 3D image representation, so that it displays the ordinary 2D image rather than 3D image. Therefore, in the embodiment of the present invention, there is no need to separately transfer either an image for 3D picture or an image for 2D picture, but an automatic display of any one of the image for 3D picture and the image for 2D picture will be made depending upon whether the image output apparatus is featured with 3D picture generation or not.

The description above relates to a specific embodiment of the invention. However, modifications may be made to the disclosed embodiment without departure from the spirit and scope of the invention. In particular, the preferred embodiment shows by way of example that a 3D picture image is generated into compressed image data that are subsequently transferred, received and outputted under the control of a controller. However, the present invention may be applied to a moving picture system in which more than one picture images are continuously displayed. Further, the embodiment disclosed shows that, for example, an MPEG4 format of image compression data may be used to describe the transfer of additional image for generation of 3D picture with user data format. However, any suitable format other than MPEG4 may be applied if it is a format of image compression data having the configuration capable of inserting extra data such as user data. Furthermore, although in the disclosed embodiment the description was made on the assumption that the additional image used for generation of 3D picture is only one image, it should be appreciated that the additional image may be more than one image. In this occasion, it would be well understood to an expert in the art that such a plurality of additional images for generation of 3D picture may be inserted into a user area of the compressed image data, as described in the above embodiment.

Accordingly, it will be appreciated that the present invention has an advantage that there is no need to separately transfer either an image for 3D picture display or an image for 2D picture display, but an automatic display of either one of the image for 3D picture and the image for 2D picture can be made depending upon whether the image output apparatus is featured with the 3D picture generation or not.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An apparatus for generating compressed image data, comprising:
a memory for storing a plurality of images for generating a three-dimensional stereoscopic image;
a user data generation unit for generating user data by compressing at least one of the images stored in the memory;
a compressed image data generation unit for generating the compressed image data from any one of the stored images, inserting the user data into a specified area of the compressed image data, and marking the compressed image data with an indication that the user data have been inserted in the compressed image data; and
a controller for controlling the user data generation unit and the compressed image data generation unit, said controller adapted to deliver the images stored in the memory to the user data generation unit and the compressed image data generation unit, and to deliver the user data generated from the user data generation unit to the compressed image data generation unit, so as to produce the compressed image data with the user data inserted therein.

2. The apparatus of claim 1, wherein the compressed image data generation unit is configured to indicate that the user data were included in the compressed image data using a User Data Flag.

3. The apparatus of claim 1, wherein the compressed image data generation unit is configured to indicate that the user data were included in the compressed image data using a User Data Start Code.

4. The apparatus of claim 1, wherein the controller is configured to extract an image not selected as an additional image and deliver the extracted image to the compressed image data generation unit.

5. A method for generating compressed image data, comprising:
storing a plurality of images for generating a three-dimensional stereoscopic image;
selecting at least one of the stored images as an additional image;
generating user data by compressing the additional image;
selecting any one of the stored images as an ordinary image;
generating compressed image data using the ordinary image;
inserting the user data into the compressed image data; and
marking the compressed image data with an indication that the user data were inserted in the compressed image data.

6. The method of claim 5, wherein said step of marking the compressed image data with an indication that the user data were inserted in the compressed image data uses a User Data Flag.

7. The method of claim 5, wherein said step of marking the compressed image data with an indication that the user data were inserted in the compressed image data uses a User Data Start code.

8. The method of claim 5, wherein said ordinary image is an image not selected as the additional image of the stored images.

9. An image output apparatus for outputting an image extracted from compressed image data, comprising:
a display unit adapted to generate and output a three-dimensional stereoscopic image;
an image data decoding unit for decoding compressed image data to extract an ordinary image, and if user data is present, further extracting the user data from the compressed image data;
a user data decoding unit for extracting at least one additional image by decoding the user data; and
a controller for controlling the image data decoding unit to extract the ordinary image by applying the received compressed image data to the image data decoding unit, controlling the user data decoding unit to extract the additional image by applying the user data extracted from the image data decoding unit to the user data decoding unit, and controlling the display unit to generate a three-dimensional stereoscopic image using the ordinary image and said at least one additional image as.

10. The image output apparatus of claim 9, wherein the controller determines whether a user data flag indicates that the user data is present in the compressed image data.

11. The image output apparatus of claim 10, wherein the controller, in response to a determination the user data is present, causes the image data decoding unit to extract the user data.

12. The image output apparatus of claim 9, wherein the controller determines whether a user data start code indicates that the user data is present in the compressed image data.

13. The image output apparatus of claim 12, wherein the controller, in response to a determination the user data is present, causes the image data decoding unit to extract the user data.

14. A method for outputting an image extracted from compressed image data, comprising:
extracting an ordinary image by decoding the compressed image data;
determining whether the decoded compressed image data is present in the user data;
extracting the user data if the user data is present in the compressed image data;
extracting at least one additional image by decoding the extracted user data; and
generating a three-dimensional stereoscopic image by performing a stereoscopic image processing with respect to the extracted additional image and the ordinary image.

15. The method of claim 14 further comprising the step of outputting the three-dimensional stereoscopic image generated using said stereoscopic image processing through a image output apparatus.

16. The method of claim 14, wherein the step of determining whether user data is present in the decoded compressed image data includes examining the User Data Flag to determine whether the user data is present in the compressed image data.

17. The method of claim 14, wherein the step of determining whether user data is present in the decoded compressed image data includes examining the User Data Start Code to determine whether the user data is present in the compressed image data.

18. An apparatus for generating compressed image data comprising:
a user data generation unit for receiving first image data from a first camera and generating therefrom first compressed image data;
a compressed image data generation unit for receiving second image data from a second camera and generating therefrom second compressed image data, wherein the compressed image data generation unit is further operable to insert the first compressed image data into a specified area of the second compressed image data to thereby generate an output image data file,
wherein the output image data file may be used by an image processing device to produce a two-dimensional image from the second compressed image data and to produce a three-dimensional image from the first and second compressed image data.

19. The apparatus of claim 18, wherein the compressed image data generation unit is further capable of indicating in the output image data file that the first compressed image data is present in the output image data file.

20. The apparatus of claim 19, wherein the compressed image data generation unit indicates in the output image data file that the first compressed image data is present in the output image data file using one of a User Data Flag and a User Data Start Code.
